(19) United States
(12) Patent Application Publication
(10) Pub. No.: US 2016/0075112 A1
(43) Pub. Date: Mar. 17, 2016

(54) JOINED-TOGETHER FIBER COMPOSITE COMPONENTS FOR AIRCRAFT OR SPACECRAFT AND METHOD FOR THE PRODUCTION THEREOF

(71) Applicant: Airbus Operations GmbH, Hamburg (DE)

(72) Inventors: Alexei Vichniakov, Hamburg (DE); Michaela Willamowski, Hamburg (DE)

(21) Appl. No.: 14/851,181

(22) Filed: Sep. 11, 2015

(30) Foreign Application Priority Data
Sep. 12, 2014 (DE) 102014013533.0

(51) Int. Cl. B32B 27/08; B32B 38/00; B32B 37/06; B32B 3/26; B32B 7/08

(52) U.S. Cl. CPC B32B 27/08; B32B 3/266; B32B 7/08; B32B 37/06; B32B 38/0012; B32B 2262/106; B32B 2605/18

(57) ABSTRACT

Joined-together fiber composite components of aircraft or spacecraft and a method for the production thereof, comprise the steps of a) positioning the components to be joined, b) determining the gap dimensions of the joint, c) positioning filling material made of thermoplastic material and the parts to be joined at the joining position, d) fixing the components to be joined by heating the filling material made of thermoplastic material, e) drilling and riveting the components to be joined.

### CROSS-REFERENCES TO RELATED APPLICATIONS

This application claims the benefit of the German patent application No. 10 2014 013 533.0 filed on Sep. 12, 2014, the entire disclosures of which are incorporated herein by way of reference.

### BACKGROUND OF THE INVENTION

For example, in aircraft construction, when CFRP skin panels, stringers, connecting brackets and circumferential stiffeners are connected, tolerances which are brought about for instance by the considerable dimensions of the components can occur. In the manufacturing of individual parts, cured stringers can be joined to a non-cured CFRP skin in an adhesive bonding process, producing a reinforced skin panel which can represent the starting component for assembling the fuselage shell. The CFRP skin panel, the stringers, connecting brackets and circumferential stiffeners can be connected by rivets.

In this case, in a first assembly step, cured connecting brackets with sealing compound can be positioned at a defined spacing on the skin panel, wherein an adhesive bond is produced between the foot of the connecting bracket and the foot of the stringer. In order in this case to achieve an adhesive surface that is as large as possible, the feet of the stringers can have protrusions, referred to as duck feet, at the positions of the connecting brackets. In addition, the duck feet can reduce the number of surfaces involved in the adhesive bond and thus reduce the quantity of surface and thickness tolerances to be taken into consideration during adhesive bonding. On account of thickness tolerances of the skin panel and the feet of the stringer profiles, and also perpendicularity tolerances of the CFRP connecting brackets, cavities, gaps, edges and joints can occur. In order to prevent stresses with static effects, for example shear forces, from occurring during the joining of the components, gaps and cavities can be compensated for.

This can be done with the aid of sealing compound in the case of small gap dimensions.

In the case of larger gap dimensions, the gap can be filled by means of liquid compensating means. These consist of base and curing agent made of mixed pasty plastic masses which cure at room temperature to form a non-deformable, solid mass. The tolerance compensating means, present in liquid form, can be applied to the components to be joined, as in an adhesive bonding process. The components can be assembled and held in an apparatus until the shim material has fully cured. Subsequently, they can be disassembled again and joined with sealing compound.

In the case of an even larger gap dimension, in which liquid tolerance compensating means are no longer used, the gap can be filled with an inlay made of a solid and liquid mixture, wherein the proportion of solid for tolerance compensation can be provided with liquid shim on both sides. CFRP or GRP plates are suitable for this purpose.

Once the liquid proportion has cured, the components can be joined using sealing compound. Once the sealing compound between the components to be joined has fully cured, the connecting brackets can be riveted to the CFRP skin in a further assembly step.

Thermoplastic connections are known and are realized by fusing the layers to be joined. Compared with thermosets, thermoplastics generally have poorer behavior with respect to creep, this being of significance particularly in aircraft construction. As a result, for structural connections and components, thermosets are preferred, or thermoplastics having a high glass transition temperature have to be used, these having to be laboriously processed.

### SUMMARY OF THE INVENTION

There was a need to reduce the effort involved in the assembly of joined fiber composite components. Surprisingly, and in an unforeseeable manner for a person skilled in the art, a method for joining fiber composite components, comprising the steps of a) positioning the components to be joined, b) determining the gap dimensions of the joint, c) positioning filling material made of thermoplastic material and the parts to be joined at the joining position, d) fixing the components to be joined by heating the filling material made of thermoplastic material, e) drilling and riveting the components to be joined, remedies the defects of the prior art. In this way, fiber composite components can be joined together in a simple method. Curing times do not occur. Disassembly and assembly steps can be reduced to a minimum. Preferably, steps a) to e) are carried out in their alphabetical order. In this case, it is preferred for the filling material made of thermoplastic material to have a glass transition temperature above 80° C. It is furthermore preferred for the filling material made of thermoplastic material to consist predominantly of material selected from PA, PPS, PP, PC and PEI. In this case, it is preferred for the filling material to consist essentially of thermoplastic material selected from PA, PPS, PP, PC and PEI, the content of said materials then being greater than 90% by weight, preferably greater than 95% by weight, particularly preferably greater than 99% by weight, in each case with respect to the overall weight of the filling material used. In this case, it is preferred for the filling material made of thermoplastic material to represent a single film layer or a stack of film layers. In this case, it is preferred for the film layer or the stack of film layers to have a thickness of up to 3 mm. In this case, it is preferred for the components to be joined to be fixed by heating the filling material with ultrasound. It is likewise preferred for the components to be joined to be fixed by heating the filling material by induction. In this case, it is preferred for the filling material to be heated by induction substantially only in the plane of the film. In this case, it is preferred for the fiber composite components to represent components made of carbon-fiber-reinforced plastic material. In this case, it is particularly preferred for the fiber composite components to be components of aircraft or spacecraft. It is very particularly preferred for the fiber composite components to be joined to represent a fully cured skin panel of an aircraft and stiffening elements such as circumferential stiffeners (frames) and/or stringers. The invention therefore also comprises joined-together fiber composite components of aircraft or spacecraft, obtainable by the method according to the invention, as set out above.

### BRIEF DESCRIPTION OF THE DRAWINGS

FIG. 1 shows a method for joining fiber composite components.

FIG. 2 shows the method according to the invention for joining fiber composite components

FIG. 3 shows handling of the filling made of thermoplastic material.

### DETAILED DESCRIPTION OF THE PREFERRED EMBODIMENTS

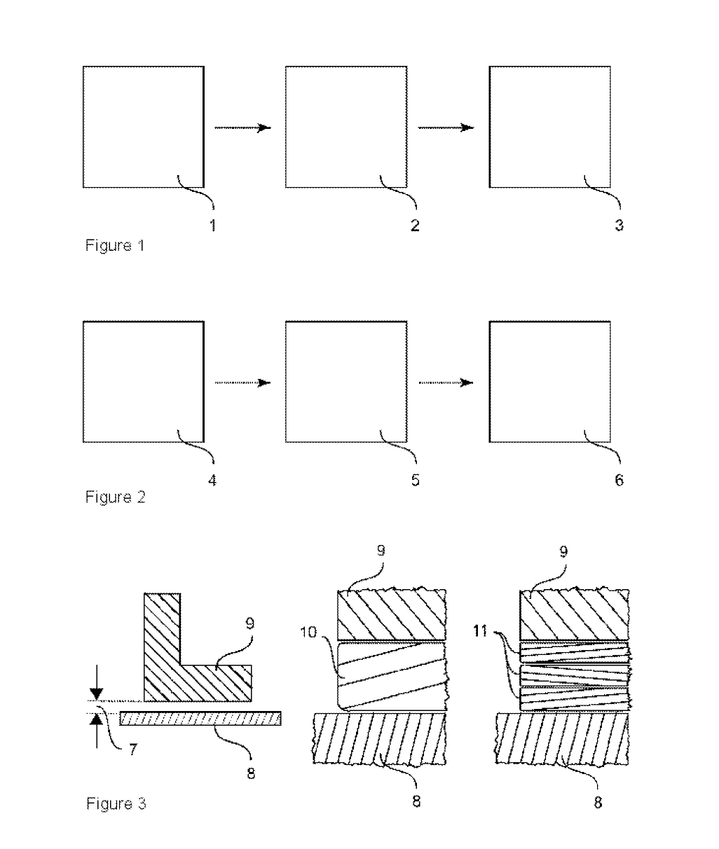

As shown in FIG. 1, the components to be joined are first of all (1) positioned one on top of another and the gap dimensions of the joint are measured, subsequently (2) the gap is filled and the filling and the parts to be joined are connected together, and finally (3) the parts to be joined and the material filling the gap are drilled and riveted.

As shown in FIG. 2, step (2) of the method, the filling of the gap and the connecting together of the filling and the parts to be joined, can be carried out as follows: First of all (4), the requirement for filling made of thermoplastic material is determined from the dimensions of the joint and the gap dimension. Subsequently (5), the filling made of thermoplastic material and the parts to be joined are positioned at the joining position and fixed, if required, by clamps. Finally (6), the filling and the parts to be joined are connected together by fusing the thermoplastic material. As a result of the subsequent solidification, the parts to be joined are connected, with the gap between them being filled. Since the connection is not conceived of as a structural connection, but rather as a tolerance compensation measure, thermoplastics having a low glass transition temperature are also suitable for this purpose.

FIG. 3 shows handling of the filling made of thermoplastic material.

The filling can consist of a piece of thermoplastic material (10) that is adapted precisely to the particular gap dimensions (7) between the components (8) and (9) to be joined. In order to be able to fill different gap dimensions using a single raw material, for example a thermoplastic film, a number of layers (11) of filling material are positioned between the components to be joined until the gap dimension has been reached.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

(1) Positioning of the components to be joined one on top of another and measuring of the gap dimensions
(2) Filling of the gap and connection of the filling and the parts to be joined
(3) Drilling and riveting of the parts to be joined and of the material filling the gap
(4) Determination of the requirement for filling
(5) Positioning of the filling and the parts to be joined at the joining position
(6) Connection of filling and parts to be joined
(7) Gap dimension
(8) Component to be joined
(9) Component to be joined
(10) Piece of filling material
(11) Layers of filling material

1. A method for joining fiber composite components, comprising the steps of:
a) positioning the components to be joined,
b) determining gap dimensions of the joint,
c) positioning filling material made of thermoplastic material and the components to be joined at the joining position,
d) fixing the components to be joined by heating the filling material made of thermoplastic material, and
e) drilling and riveting the components to be joined.

2. A method according to claim 1, wherein the filling material made of thermoplastic material has a glass transition temperature above 80° C.

3. The method according to claim 1, wherein the filling material made of thermoplastic material comprises predominantly of material selected from PA, PPS, PP, PC and PEI.

4. The method according to claim 1, wherein the filling material consists essentially of thermoplastic material selected from PA, PPS, PP, PC and PEI.

5. The method according to claim 1, wherein the filling material made of thermoplastic material consists of a single film layer.

6. The method according to claim 1, wherein the filling material made of thermoplastic material comprises a stack of film layers.

7. The method according to claim 5, wherein the film layer has a thickness of up to 3 mm.

8. The method according to claim 6, wherein the stack of film layers has a thickness of up to 3 mm.

9. The method according to claim 1, wherein the components to be joined are fixed by heating the filling material with ultrasound.

10. The method according to claim 1, wherein the components to be joined are fixed by heating the filling material by induction.

11. The method according to claim 10, wherein the filling material is heated by induction substantially only in the plane of the film.

12. The method according to claim 1, wherein the fiber composite components represent components made of carbon-fiber-reinforced plastic material.

13. The method according to claim 1, wherein the fiber composite components are components of aircraft or spacecraft.

14. The method according to claim 1, wherein the fiber composite components to be joined represent a fully cured skin panel of an aircraft and stiffening elements.

15. Joined-together fiber composite components of aircraft or spacecraft, obtainable by the method according to claim 1.
